(19) United States
(12) Patent Application Publication
(10) Pub. No.: US 2007/0067177 A1
(43) Pub. Date: Mar. 22, 2007

(54) QUALITY ASSURANCE SYSTEM AND METHODS OF USE

(75) Inventors: Jean-Paul Martin, London (GB); Serge P. Gozlan, Paris (FR); Thaddeus Prusik, Stroudsburg, PA (US); Christopher Caulfield, Long Valley, NJ (US)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(73) Assignee: Temptime Corporation, Morris Plains, NJ (US)

(21) Appl. No.: 11/468,127

(22) Filed: Aug. 29, 2006

Related U.S. Application Data
(60) Provisional application No. 60/712,929, filed on Aug. 31, 2005.

(51) Int. Cl. G06Q 99/00

(52) U.S. Cl. 705/1

(57) ABSTRACT

A quality assurance system having an ambient condition indicator provides a current visual indication of the cumulative exposure over time of a host product to an ambient condition such as temperature or humidity. The indicator's visual response is correlated with the response characteristics of any one of a wide range of specific host products including foods, drugs and vaccines, industrial and other products whose quality is related to condition-exposure over time. The system includes a historical record with one or more historical visual indications of past cumulative exposures. An airline meal can be accompanied by a novel freshness certification document which can simulate a travel document and provide, in a graphically appealing manner, a verified indication of the freshness of the meal served. Also disclosed are a novel quality assurance document and method and a cold chain monitor.

### CROSS-REFERENCE TO A RELATED APPLICATION

This application claims the benefit of Provisional Patent Application No. 60/712,929 filed Aug. 31, 2005, having first inventor Jean-Paul Martin and entitled “Freshness Tracking”.

### STATEMENT REGARDING FEDERALLY SPONSORED RESEARCH OR DEVELOPMENT

(Not applicable.)

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

The present invention relates to a novel quality assurance system and to methods of use of the quality assurance system. One embodiment provides a novel, active freshness-indicating document useful to indicate the freshness of an associated consumable host food product or food service product and to a novel combination of the freshness document with an associated host product.

The invention includes methods such as delivery and marketing methods employing the novel freshness document. Other embodiments relate to novel quality assurance systems and their use for assuring the freshness of perishable products other than food or food service products, for example drugs, vaccines, perishable industrial products, munitions prone to develop instability and other perishable products. Still further embodiments relate to novel quality assurance systems and their use for assuring the maturity of maturing products, for example, fruits, cheeses, wines or other than food or food service products.

Freshness indicators are known which incorporate an active time-temperature element to provide a visual indication of the freshness of an associated perishable host product, for example a vaccine or a foodstuff. Typically, the visual signal may be provided by a change in color, or visual intensity, of an indicator area. The color change may be provided by a suitable active indicator component for example a chemically acting agent, such as a substituted diacetylenic compound, or other suitable active element or elements.

The response characteristics of the substituted diacetylenic compound or other active indicator component can correlate with known response characteristics of the host product to the ambient condition, for example temperature. Appropriate correlation can result in a good probability that the indicator will provide a meaningful indication of the ambient-condition related quality of the host product.

The visual signal from the indicating area of the freshness indicator may be enhanced by providing an adjacent reference area having a visual appearance that facilitates interpretation of the active indicator area. Known freshness indicators can be incorporated in an economical product label or tag, if desired. The label or tag may be attached to the package of an individual host product item, or otherwise associated with the host product so as to subject the indicator to similar conditions to those experienced by the host product. Such freshness indicators are valuable for their ability to provide a consumer, a health worker or other user with a clear visual signal indicating the probable freshness of a specific associated host product item. The associated host product item can, for example, be an individual dosage of a vaccine or medication, or an individual food portion.

Such time-temperature indicators, for example indicators available from TEMPTIME Corporation, Morris Plains N.J., under the trademark FRESH-CHECK® have been used to indicate the freshness and safety of foods in supermarkets and elsewhere. It is also known to use time-temperature indicators with appropriate algorithms to indicate the heat damage status of vaccines. For example, TEMPTIME Corporation supplies vaccine condition indicators under the trademark HEATmarker® which are, at the date of this application, approved for use by WHO and UNICEF in their global vaccination programs.

Commonly owned U.S. patent application Ser. No. 11/119,650 filed May 2, 2005, first inventor Prusik, describes and claims the use of a visual indicator responsive to cumulative exposure to temperature, humidity, atmospheric conditions and/or other environmental conditions to indicate the maturity of a maturing consumable product. The invention of said application is useful for indicating the maturity of host products lacking a clear visual indication of maturity or ripeness, for example certain pears, other fruit, some cheeses, aged beef, sausages, wine and other maturing products.

The above-described indicators provide a simple, useful system for assuring the quality, with respect to freshness of a particular perishable host product, or with respect to maturity of a particular maturing host product. They can provide a viewer an easily understood visual signal indicative of the actual historical exposure of the host product to the ambient condition of interest and thence of the probable quality of the host product.

Such time-temperature indicators are effective for their intended purposes, and other ambient condition indicators may also be effective for their intended purposes. However, pursuant to the present invention it has been ascertained that there is a need for a system which provides additional assurance as to the probable quality of a host product subject to quality change in response to exposure to one or more ambient conditions.

A World Health Organization (“WHO”) publication, “Temperature Monitors for Vaccines and the Cold Chain” WHO/V&B/99.15 (1999) (“the WHO publication” hereinafter) describes, at pages 6-10, a cold chain monitor for monitoring exposure of vaccines to temperatures above a safe range during transportation and storage. Each cold-chain monitor is intended for use with a bulk supply of vaccine. Vaccine manufacturers are instructed to provide one cold-chain monitor per 3000 doses of DTP, measles or yellow fever vaccine and/or one per shipment of polio vaccine (page 10).

The WHO publication describes a cold-chain monitor comprising a card on which is mounted a two-component indicator (2) having parts ABC and D. Part ABC is to respond to temperatures above +10° C. and part D to temperatures above +34° C. As described, the card has a front and a back. As shown, the front includes a record form (1) an indicator (2), an interpretation guide (3) and supplier information (4). The back includes instructions on use (5) and a table giving information on the time and temperature characteristics of the indicator (page 7). Instructions (5) direct personnel to complete record portion (1) with information regarding receipt and dispatch of the vaccine, the relevant dates and a code letter or letters, “the index”, to indicate the reading of the indicator (2) at the time of receipt or dispatch of the vaccine.

Also, as described, the WHO publication cold-chain monitor shows exposure to temperatures above the safe range during transportation and storage. Exposures to temperatures below the safe range are apparently not tracked and the monitor apparently does not monitor the quality of an associated host product. Thus, as described the cold chain monitor does not provide an indication of the probable quality of a vaccine. Furthermore, the indicator employed is apparently not correlated with the characteristics of a particular vaccine: the same cold-chain monitor is described as being used for a variety of vaccines. In the event that a break in the cold chain is identified, the user is instructed to check the readings of other indicators, namely vaccine vial monitors (“VVMs”), if supplied, and to investigate the stores and transport facilities in the cold chain (bottom of page 9). If no VVM is supplied, vaccines may have to be tested before use (page 7), according to the publication's instructions. Thus, the cold-chain monitor described in the WHO publication does not provide appear to provide any new level of assurance as to the probable quality of a host product subject to quality change in response to exposure to one or more ambient conditions.

The foregoing description of background art may include insights, discoveries, understandings or disclosures, or associations together of disclosures, that were not known to the relevant art prior to the present invention but which were provided by the invention. Some such contributions of the invention may have been specifically pointed out herein, whereas other such contributions of the invention will be apparent from their context. Merely because a document may have been cited here, no admission is made that the field of the document, which may be quite different from that of the invention, is analogous to the field or fields of the present invention.

### SUMMARY OF THE INVENTION

One problem solved by the invention is the problem of providing a new level of quality assurance for consumers and users of specific host products whose quality is time related to exposure to an ambient condition. For example, the quality of certain perishable and maturing or maturable host products is related to cumulative temperature exposure.

Accordingly, to solve this problem, in one aspect the invention provides a quality assurance system for assuring the quality of an associated specific host product which quality is time related to exposure to an ambient condition for example temperature.

The quality assurance system comprises an ambient condition indicator and a historical record. The ambient condition indicator can provide a current visual indication of the cumulative exposure over time of the host product to the ambient condition and has an active component selected to provide a visual response to the ambient condition in a manner correlated with the response characteristics of the specific host product to the ambient condition.

The historical record can provide at least one historical visual indication of cumulative exposure over time of the host product to the ambient condition at a prior point in time. The quality assurance system communicates to a human viewer a verified data signal regarding the ambient condition-related quality of the host product. The verified data signal can comprise the current visual indication and the at least one historical visual indication of the cumulative exposure over time of the host product to the ambient condition.

In one embodiment the invention provides a novel active freshness document particularly, but not exclusively, suitable for use in the food service industry.

The invention also provides novel service and/or marketing methods utilizing the inventive freshness document in ways that enhance a vendor's quality message and image.

In a further aspect, the invention provides a freshness-indicator document intended to be associated with a host perishable product, for example a foodstuff or food preparation service, the freshness indicating document comprising:
a) an active time-temperature monitoring element to provide a visual indication of probable freshness of the host product; and
b) at least one historical record visually indicating a prior freshness condition of the host product at a point in time;
   wherein the freshness document has a graphic appearance facilitating comprehension of the information conveyed by the time-temperature monitoring element and the historical record.

Desirably, the freshness monitoring document has an aesthetically appealing visual appearance and multiple graphic design elements enhancing the presentation of the real time and historical freshness information in a consumer-friendly manner whereby consumers or others unfamiliar with the freshness document can readily comprehend its message. For example, the graphic design elements may include one or more guide-like depictions of the time-temperature monitoring element in various stages of exposure labeled with corresponding degrees of freshness.

The invention includes a novel food service concept wherein a ready-to-eat meal is accompanied by the inventive freshness document to provide the meal consumer an appealing freshness message in an unmistakable and attractive form.

The inventive freshness document can comprise a certificate or diploma or other suitable document. Desirably, the document is provided with multiple visual design elements which include at least one active freshness indicator and cooperate to suggest to a viewer the appearance of an official certificate or authorization, possibly government-issued and optionally suggesting a travel document.

Ingeniously so suggested, the concept of an official travel authorization, conveys to the viewer, who may desirably be an actual or prospective customer, an expectation that the interior of the document will bear stamps received at points of travel during the life of the travel document. This concept is uniquely appropriate to the meal or other freshness-dependent product received by the customer, who may be gratified to find within the inventive freshness document a series of stamps, dates, signatures or the like, applied as original marks to the specific document associated with the meal or other product served to the customer, and which affirm a designated freshness standard was met at each of multiple points in the life of the product prior to its reaching the customer.

Some desirable embodiments of the inventive freshness document comprise multiple historical records, each visually indicating a prior freshness condition at a point in time.

While not so limited, the invention can be beneficially be employed in the food service industry for the service of, for example, airline meals, institutional meals or the like.

By use of a visual reference area, the invention can provide a simple binary visual indication of the current and historical exposures of a specific product enabling a viewer easily to see whether the indication does or does not meet desired criteria. In contrast, known devices that fail to use an active indicator component with an algorithm matched to host product response characteristics may be unable to provide a simple and precise, exposure signal.

In a further aspect, the invention provides an active cold chain compliance monitor for monitoring the compliance of a cold chain having multiple distribution stages with prescribed cold standards. The active cold chain compliance monitor can comprise an integrated time-temperature indicator and a record area. By appropriate selection of the integrated time-temperature indicator, the cold chain monitor, or distribution temperature monitor can be used to monitor distribution chains subject to room temperature standards or another temperature regimen.

The integrated time-temperature indicator can provide a current visual indication of the cumulative exposure of the active compliance monitor to temperature over time. The time-temperature indicator can have an active component providing a changing visual response to cumulative ambient temperature.

The record area can provide multiple stage records corresponding one to each with said distribution stages. The records can be marked for completion with chronological notations, distribution stage identification and information regarding the visual appearance of the time-temperature indicator when the active compliance monitor was at the respective distribution stage.

The invention also provides, in a still further aspect a method of assuring the quality of a specific host product having a quality characteristic time-related to exposure of the host product to an ambient condition. The method comprises employing a quality assurance system having an ambient condition indicator for providing a current visual indication of the cumulative exposure over time of the host product to the ambient condition. The ambient condition indicator has an active component selected to provide a visual response to the ambient condition in a manner correlated with the response characteristics of the specific host product to the ambient condition. Also, the quality assurance system has a historical record for recording a historical visual indication of cumulative exposure over time of the host product to the ambient condition at a prior point in time.

The method further comprises, at said prior point in time, observing the appearance of the ambient condition indicator and, also at said prior point in time, recording the appearance of the ambient condition indicator in the historical record.

The specific host product can comprise a food service meal, the assured quality of which is freshness. The ambient condition can be temperature and the prior point in time can be a point during the preparation of the food service meal. In one embodiment the quality assurance system comprises a quality assurance document and the method comprises serving the meal to a customer and displaying to the customer, when served, the ambient condition indicator and the historical record in the quality assurance document. Viewing the historical record with an indication of the freshness of the meal during its preparation reinforces the freshness signal provided by the ambient condition indicator, enhancing the customer's appreciation of the quality of the meal.

In one embodiment, the method can be effected by an entity having a facility to accommodate a food-consuming population and can comprise service of multiple ones of said food service meals to the food-consuming population. Each meal can be accompanied by one of said quality assurance documents, and can include the ambient condition indicator either as a component of or attached to the quality assurance document or as a separate element. Desirably, the ambient condition indicator is associated with the meal during its preparation.

### BRIEF DESCRIPTION OF THE SEVERAL VIEWS OF THE DRAWING

The following description is to be read as a whole in conjunction with the preceding description. Some embodiments of the invention, and of making and using the invention, as well as the best mode contemplated of carrying out the invention, are described in detail below, by way of example, with reference to the accompanying drawings. In the drawings, like reference characters designate like elements throughout the several views and:

FIG. 1 is a plan view of the outer cover of one embodiment of a quality assurance system according to the invention comprising a freshness certificate having a bi-fold configuration and which is employed to certify the freshness of a host food product (not shown);

FIG. 2 is a plan view of the interior of the freshness certificate shown in FIG. 1;

FIG. 3 is a schematic flow diagram of one method of marketing or delivering a host food employing the freshness certificate shown in FIG. 1;

FIG. 4 illustrats an airline, or other, meal tray provided with the quality assurance system shown in FIGS. 1 and 2; and

FIG. 5 illustrates a cold chain compliance card according to another embodiment of the invention.

### DETAILED DESCRIPTION OF THE INVENTION

The present invention provides a novel quality assurance system, and method, for assuring the quality of an associated specific host product, the quality of the host product being time related to exposure to an ambient condition, for example temperature. Quality characterstics assured or assurable include freshness, maturit and ripeness. Other characterstics that may be assured by means of the invention will be apparent to those skilled in the art. The invention also provides a novel cold chain compliance record.

A “specific host product” or “specific product”, as used herein includes a commercial product having a particular identifiable character and its own ambient condition response parameters. Examples include diphtheria vaccine, measles vaccine, apples, pears, steak, shrimp and a food service meal of a specified composition such as a meal comprising salad, lasagna, roll and butter, apple pie and cream. A “specific product” is not intended to include generic product groups such as “fruits” or “vaccines” which may include within the genus referenced individual products having significantly different condition response characteristics.

A specific host product may be packaged or loose, for example pieces of fruit, and may be handled as individual product items, packages of a small number of items, cartons, crates or the like of large numbers of items, in bulk or in other suitable manner. In this context “product item” is used herein to include a single item of a product such as a vaccine vial, an apple or a pear, or a relatively small package such as an end user may receive, for example a meal or a pound of shrimp. The term “product item” is intended to distinguish from bulk packaged cartons or crates or the like of one or more dozens of items commonly available individually.

As described herein the invention provides a quality assurance system which comprises an ambient condition indicator and a historical record. In some embodiments, the quality assurance system comprises a quality assurance document including the historical record. The ambient condition indicator is associated with the host product to monitor exposure of the host product to the ambient condition but the quality assurance document may not necessarily be so associated.

Pursuant to a further embodiment in which the quality assurance system comprises a quality assurance document, the quality assurance document includes both the historical record and the ambient condition indicator. In this case the quality assurance document itself is associated with the host product to monitor exposure of the host product to the ambient condition. If desired, the ambient condition indicator, including the active indicator component, can be mounted on the quality assurance document, for example, self adhesively and optionally, removably. The active indicator component can be a printable ink comprising for example a dispersion of a substituted diacetylenic color-changing agent in a liquid vehicle. The active indicator component can be printed on a removable label, or possibly, on the quality assurance document itself.

The historical record can comprise multiple historical visual indications and each historical record visually indicates a prior freshness condition at a point in time stated in the historical record.

The invention includes embodiments wherein the quality assurance document comprises multiple graphic design elements giving the quality assurance document an aesthetically appealing visual appearance. There may be multiple visual design elements that are cooperative to simulate an official certificate or authorization, for example a travel document.

In some useful embodiments of the invention, the specific host product can comprise a food service meal and the quality assurance system can comprise a quality assurance document having a cover which is openable to display an inside surface or surfaces. The inside surface or surfaces can comprise multiple stamps, dates and/or signatures applied as original marks to a specific copy of the document associated with each serving of a specific food service meal. These indicia may verify compliance with a predetermined freshness standard at each of multiple time points in the life of the food service meal prior to service of the food service meal to a customer.

In another embodiment of the invention the quality assurance document comprises a bifold sheet of a size and configuration permitting the quality assurance document to be handheld and read. The quality assurance document can comprise an outside cover having a front panel and a back panel. The document can comprises an interior having a lefthand panel and a righthand panel. The front panel of the document, can bear a simulated freshness indicator and, optionally, a freshness message to convey the function of the quality assurance document.

In one embodiment of the invention the host product is an airline meal and the front cover of the quality assurance document comprises a graphic depiction of the world, suggesting travel via air. If desired, the quality assurance document can have a hinge between the panels enabling the lefthand panel to be folded over the righthand panel. The panels can be rectangular and the quality assurance document can simulate a travel document.

The quality assurance document can be formed of card, plastic or heavy duty paper or a combination of two or more of card, plastic and heavy duty paper or other suitable material as will be known or apparent to one skilled in the art.

The host product quality assured can be freshness, ripeness or maturity and the quality assurance document can evidence that the associated host product meets a maturity or freshness standard. Current and recent-history ambient condition exposure information provided by the quality assurance system can be derived from real-time data generated by the ambient condition indicator.

A color-changing substituted diacetylenic compound may be employed as the active indicator component. The response characteristics of the substituted diacetylenic compound or other active indicator component can be correlated with known response characteristics of the host product to the ambient condition, for example temperature. For example a chemically active indicator component may have a response algorithm that is correlated with the response characteristics of the intended host product by chemical treatment. Alternatively, or in addition a chemically active indicator component may be matched with the response characteristics of the intended host product by selection of a suitable active indicator component from a range of available indicator components having various ambient condition response characteristics.

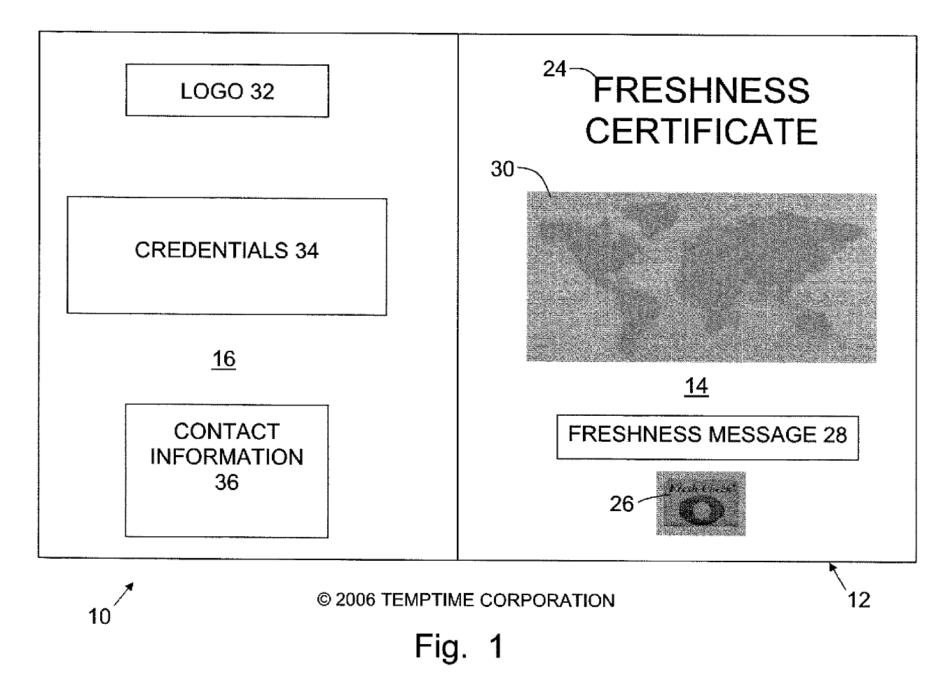

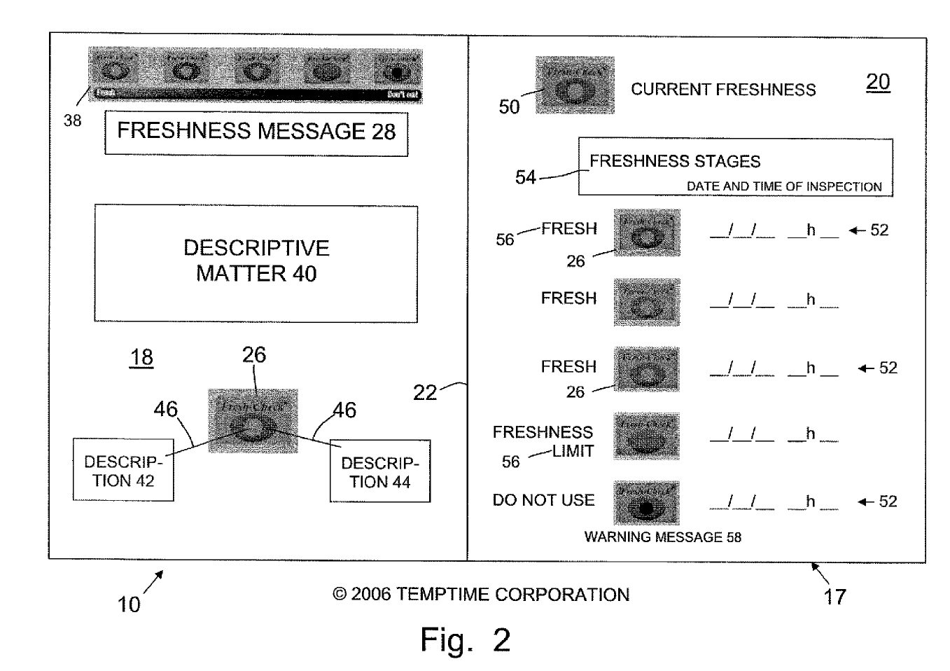

Referring now to FIGS. 1-2, the freshness certificate 10 there shown comprises a bifold sheet of heavy duty paper, card, plastic or other suitable material of a size an configuration enabling it to be easily handheld and read. As shown in FIG. 1, freshness certificate 10 comprises an outside cover 12 having a front panel 14 and a back panel 16. As shown in FIG. 2, the interior 17 of freshness certificate 10 comprise a lefthand panel 18 and a righthand panel 20.

A crease or hinge 22 between the panels enables the lefthand panel 18 to be folded over righthand panel 20 like a booklet, a brochure or a travel document. Freshness certificate 10 can have any desired size, for example, referring to the folded configuration, and the rectangular shape shown, from about 25 mm (about 1 inch) to about 250 mm (about 10 inches) along the shorter side and from about 30 mm (about 1.2 inch) to about 300 mm (about 12 inches) along the longer side.

Freshness certificate 10 can be employed to certify the freshness at a point of delivery or consumption or other point of handling of any one or more of a variety of perishable products, including without limitation, cooked and/or uncooked food products including fruits, cheeses, steaks and smoked and/or aged meat products. In one useful embodiment of the invention the host product is a food service product and can comprise, for example, a prepared meal such as an airline meal which can include one or more of uncooked fresh foodstuffs and hot or cold cooked foodstuffs.

In alternative embodiments of the invention, freshness certificate 10 can have a shape other than rectangular, for example, square, circular, or another shape for example a fanciful shape such as arrow-shaped, or a shape depicting or suggesting an airplane, a bird, a train, a steak, a fish, a chocolate or the like, according to what may be appropriate or interesting for the intended host product. Other embodiments of the invention can employ alternative configurations to bifold, for example single sheet or page, trifold in concertina, gate-fold, or shutter-fold style, a concertina fold having four or more panels or even a multi-page booklet suggesting the multiple pages commonly found in travel documents.

Front panel 14 of cover 12 bears a title 24, prominently rendered in large lettering, at the top of the panel and a simulated freshness indicator 26 is positioned at the bottom of the panel. Simulated freshness indicator 26 can be closely accompanied by a freshness message 28 that helps convey the function of freshness certificate 10. A visually appealing graphic image 30 is located in a central area of front panel 14. The freshness indicator simulated may be any suitable indicator that can effectively monitor the freshness of the host product or one or more conditions related to the freshness. For example, as shown, a proprietary time-temperature sensitive adhesive label having the distinctive appearance shown and bearing the trademark FRESH-CHECK®, which is supplied by TEMPTIME Corporation, Morris Plains, N.J., may be employed.

Usefully, a title 24 is chosen that communicates the function of the document, being, in the example shown in the figure, that of a freshness certificate. A freshness certificate can be understood as a document which evidences that a freshness standard has been met. More particularly, in the whole context of the illustrated embodiment of the invention, the term “freshness certificate” may be understood to suggest or imply that an associated product to which the freshness certificate relates has been examined, inspected and/or monitored for freshness.

An alternative embodiment to the one shown employs a title such as PASSPORT FRESH-CHECK™ (trademark, TEMPTIME Corp.) or PASSPORT HEATmarker™ (trademark, TEMPTIME Corp.) helping suggest the character of a personal travel document used to identify a host bearer of the travel document and to permit travel from country to country. A real travel document may also have dated stamps indicating that the document and associated subject, the bearer have been inspected or examined at specific check points along their way. These features are relevant, in a fanciful way, to freshness certificate 10, as will be explained hereinbelow.

Simulated freshness indicator 26 can comprise a nonworking image of a suitable visually responsive freshness indicator employed to monitor the freshness of the host product.

Freshness message 28 is selected to work with the other design elements 24, 26 and 30 on front cover 14 to help convey the purpose and character of freshness certificate 10, many of the recipients of which may be viewing it for the first time. To this end a message such as FRESHNESS YOU CAN SEE™ or AN EXTRA CHECK FOR FRESHNESS™ (both are trademarks of TEMPTIME Corporation.) may prime the viewer to look inside the document for a visible freshness indicator.

Graphic image 30 desirably is selected to provide a focal point of interest on front cover 14 and to relate to the host food product. The graphic image 30 selected for use in FIG. 1, a world map, is germane to a host food product such as an airline meal, connecting strongly with the concept of travel. Also, a world map contributes to the message conveyed by the front cover as a whole. Use of a world map for image 30 also helps suggest a travel document-like image for freshness certificate 10. Coupled with the ideas conveyed by title 24 and freshness message 28 the image of a world map suggests the host product will be fresh wherever in the world the recipient may be.

The interior of freshness certificate 10 delivers on the promise of cover 12, providing a convincing assurance of freshness of the host food product, as will be explained hereinbelow.

Simulated indicator 26 on front panel 14 primes the customer, or other recipient of freshness certificate 10, to more quickly comprehend what they will find within freshness certificate 10, namely an active freshness monitor and recent history freshness information derived from real-time data generated by the freshness monitor or indicator.

Rear panel 16 comprises three informational elements concerning the provider of the freshness certificate, namely a logo 32 at the top of panel 16, credentials 34 in the middle of the panel and contact information 36 at the bottom of the panel. For example, a logo 32 and contact information 36 of the assignee herein, Temptime Corporation can be employed. Logo 32 desirably has an appealing graphic appearance enhancing typescript, if employed with special visual effects, coloring, special characters, geometric and/or other image elements, and so on. Usefully, logo 32 can include a slogan or other message which helps demonstrate the authenticity of freshness certificate 10. For example, Temptime might employ, as a component of logo 32, a slogan such as “Scientific credibility and proven reliability”. Such an assertion can be supported by credentials 34. Temptime could here describe their credentials in terms such as the following:
“TEMPTIME's indicators serve WHO's demand for a time-temperature indicator capable of ensuring that children's polio vaccines had not been inactivated by exposure to heat. Credibility in healthcare applications is confirmed by the fact that WHO now requires major pharmaceutical laboratories (e.g. Aventis-Pasteur, GlaxoSmithKline, Chiron, etc.) to use this indicator for vaccines administered under UNICEF vaccination campaigns.”

Other suppliers may have other logos, slogans, credentials and contact information, or make other uses of rear panel 16. Usefully, rear panel 16 conveys to the reader the identity of the supplier of the freshness monitoring technology and sufficient information to give the reader confidence that the freshness of the host food product has been efficiently and reliably monitored. This information helps imbue the reader with a sense of the credibility and authenticity of the freshness certification provided by freshness certificate 10.

Referring now to FIG. 2, lefthand panel 18 of interior surfaces 17 of freshness certificate 10 comprises an arrangement of text and graphics which explains the freshness theme communicated by front cover 14. The panel elements are selected and laid out to provide easily assimilated education as to how host product freshness is monitored. Here smaller versions of indicator images 26 are repeated in a non-tedious way and the properties of the indicator are explained.

Displayed in an upper portion of lefthand panel 18 where they provide an ornamental appearance and subtly condition the reader as to the subject matter set forth in the page or panel is an indicator guide 38, in the form of a display strip of indicator images, each of which is preferably similar to indicator image 26 as shown on front cover 12. As illustrated, indicator guide 38 shows different degrees of development of indicator as progressive darkening of a portion of the indicator from one image to the next reading from left to right. The darkening correlates with loss of freshness, as is simply communicated by the shaded bar running beneath the several indicator images which bar is labeled “Fresh” at its lefthand end and “Don't eat” at its righthand. Indicator guide 38 helps lead the reader, in an easily followed, non-intimidating manner to understand how the freshness indicator works and provides a convenient reference.

Beneath indicator guide 38, freshness message 28 is repeated, helping communicate that what was suggested on cover 12 is here expanded.

A block of descriptive matter 40 occupies the center of lefthand panel 18. Here, detailed indicator information is presented as a non-intimidating manageable portion between visually interesting design elements above and below it. Descriptive matter 40 can comprise a simple description of how the time-temperature indicator monitors freshness. For example, descriptive text 40 may explain that the indicator used comprises an adhesive label that has an active area wherein resides a chemically reactive agent which changes color irreversibly in response to ambient temperature changes, along with a comparative reference area.

One example of text for descriptive matter 40, suitable for employment by supplier TEMPTIME Corporation is as follows:
“The Fresh-Check® dot takes the form of an adhesive label containing a reactive substance that changes colour irreversibly, by polymerisation, in response to time and temperature exposure. It provides a clear, instant, visual indication of product freshness: users just compare the colour of the inner dot against the colour of the outer ring.”

Located in the lower portion of lefthand panel 18 is a further rendering of indicator image 26 accompanied by descriptions 42, 44 of its components keyed to the image 26 by reference lines 46. This schema enables the reader to better comprehend the ideas conveyed in descriptive matter 40 and to easily interpret freshness indicator 26. For example, the text can be written to be comprehensible to an average American- or European-educated thirteen-year-old. Descriptions 42, 44 can explain the working of the particular freshness indicator employed. For example, description 42 may describe how freshness indicator 26 has a color-changing center ring containing an active indicator material programmed or selected to have a response algorithm appropriate for the intended host food product. Description 44 can describe how freshness indicator 26 also has a reference of predetermined color whereby matching of the center ring with the reference ring indicates a freshness limit.

In one exemplary embodiment, description 42 can read as follows:
“Reactive substance. Programmable from three days to several months. Custom-designed for each product in accordance with manufacturer's standards.”

For such an embodiment, description 44 relating the indicator reference area, here called a “control ring” can read as follows:
“Control ring: Printed in set colour: freshness limit reached when inner dot colour matches outer ring colour.”

Other suitable descriptions meeting the objectives of the invention, as described herein, may be employed for different freshness indicators, indicator technology or indicator vendors, as will be understood by those skilled in the art.

Thus, lefthand panel 18 can provide a complete, easy-to-absorb guide to the structure and function of active indicator 50 employed to monitor cumulative external temperature exposure over time as a basis for indicating the freshness of the host food product. The viewer or reader is smoothly guided, with little effort on their part, to follow the idea presented on front cover 12, connecting therewith via the simulations of freshness indicator 26 and repetition of freshness message 28 to follow, in descriptive matter 40, an explanation of the principles of freshness monitoring employed to a simple, but detailed explanation, of how to interpret the freshness indicator, in descriptions 42, 44. Even readers who are viewing freshness certificate 10 for the first time are now well prepared to understand it. In addition, lefthand panel 18 provides a convenient reference for someone looking at righthand panel 20.

The structures and information incorporated in righthand panel 20 provide a meaningful history and current status of the freshness of the host product. At the top of panel 20 is an actual, not simulated, active freshness indicator 50 which in this embodiment is affixed to freshness certificate 10, or otherwise initiated, at the beginning of the freshness period. In alternative embodiments, freshness indicator 50 is removable from freshness certificate 10 or is a separate element.

Active indicator 50 can, for example, be a cumulative time-temperature indicator such as that supplied under the trademark FRESH CHECK® by TEMPTIME Corporation, Morris Plains, N.J., an embodiment of which is shown in the figure. Such indicators can be closely associated with a host product, for example by being affixed thereto e.g. by adhesive and monitor the cumulative exposure over time to fluctuating ambient temperatures. Indicator 50 responds to predetermined cumulative exposures with a visual change such as darkening or color change, e.g. by changing from light or white to blue or dark. Desirably, indicator 50 responds irreversibly to provide a permanent visual change. Indicator 50 can be matched to the characteristics of a host food or other product by selecting for use in the indicator an active agent or agents having a suitable response algorithm corresponding with the host product characteristics.

Optionally, freshness indicator 50 can be accompanied by a suitable text or other label which might read “current freshness”, as shown, “freshness status” or “active freshness” or have other suitable language. In one desirable embodiment freshness indicator 50 comprises an adhesive label which is withdrawn from cold storage at the beginning of the freshness period to initiate it and applied to the top of panel 20, as shown, where the desired location for affixing the label can be marked, and may include instructive indicia, for example “Affix indicator label here.”

Other embodiments of freshness indicator 50 can be initiated differently, e.g. by manipulation of a pull strip or tab, and have different indicator characteristics, as is known or will become known to those skilled in the art. Freshness indicator 50 reliably detects and records the cumulative ambient temperature exposure of freshness certificate 10 from the moment of initiation. In the illustrated embodiment, freshness indicator 50 has a center dot which is initially light and which darkens with increasing cumulative exposure. Other suitable graphic designs effect an equivalent visual communication of freshness will be apparent to those skilled in the art or will become apparent.

Indicator Active Agent. Freshness indicator 50 can have an active indicator component, for example a chemically active agent, which is responsive to a wide range of ambient temperatures. One embodiment of useful active indicator component is responsive to any temperature within a range of from about −20° C. to about 60° C. Such a range is useful to accommodate the experience of host products that may be exposed to a wide variety of conditions including not only day-to-day indoor and outdoor temperature conditions, but also low-temperature storage and exposure conditions such as or such as are induced by desert or tropical heat. At the lowest temperatures, the response of the active indicator component may be only gradual, but perceptible over an adequate time period, while it may be relatively rapid at higher temperatures. Some intended host products may have comparable temperature response characteristics.

Other embodiments may be responsive to temperatures in other ranges, for example from about 0° C. to about 40° C. or other suitable range appropriate to the expected exposure of an intended host product.

A chemically active indicator agent, if employed, may be incorporated in an ink or be otherwise utilized and may comprise a suitable compound or compounds as is known to those skilled in the art. Suitable compounds include a polyacetylenic active agent which provides a visual response to environmental exposure to temperature, moisture, or other targeted environmental condition. Some useful polyacetylenic active agents include substituted diacetylenic agents such, for example, as: 2,4-hexadiyn-1,6-bis (ethylurea), also known as “KE monomer”; 2,4-hexadiyn-1,6-bis (propylurea) also known as “KPr monomer”; and co-crystallized acetylenic agents, such as a 2:1 co-crystallized mixture of the KE and KPr monomers, which mixture is also known as “KX monomer”.

Other polyacetylenic agents may be employed as is known, for example, from Patel U.S. Pat. Nos. 4,189,399 and 4,384,980 and Preziosi et al. U.S. Pat. Nos. 4,789,637 and 4,788,151. The disclosure of each one of the aforementioned Patel and Preziosi patents is hereby incorporated herein by this specific reference thereto. Those skilled in the art will understand modifications that may be made to such agents including broad ranges of substituents that may be made and complexes in which they may be incorporated, as well as methods of synthesis and blending and co-crystallization operations that may be employed to provide visually active condition-sensing agents useful in the practice of the present invention.

In the foregoing description, reference has been made to the use of color- or reflectivity-changing time-temperature indicators for freshness monitoring. As is well known, such indicators can employ chemical polymerization-based active agents. A wide range of suitable such active agents is known, effective and commercially available at low cost, e.g. from the assignee herein, TEMPTIME Corporation, Morris Plains, N.J. Other suitable active agents to be developed in the future can also be employed. Some indicators utilizing such technology which may be employed in the practice of the invention are disclosed in Patel U.S. Pat. Nos. 5,254,473; 5,053,339 and 5,045,283, the disclosure of each of which patents is hereby incorporated herein by this specific reference thereto.

Many polyacetylenic indicator agents darken with exposure to temperature or other ambient conditions. If desired, chemically active indicator agents which are initially dark and which lighten in response to exposure to ambient temperature or other ambient conditions, may be employed. Initiation of the active indicator component by application of ultraviolet radiation, other actinic radiation, mechanical or other suitable means may be employed if desired.

The indicator agent can have a rating to describe its ambient condition response characteristics, or performance algorithm. For example, one indicator agent may be rated for 5.1 days at 8° C. and another may be rated for 3.4 days at 8° C. Equivalent exposures at other temperatures can be mathematically or experimentally determined, as is known in the art. In response to its rated exposure, such an indicator can darken to a predetermined end-point having a visual appearance the reflective optical density of which can be measured. The visually responsive active area of the indicator can be accompanied by an adjacent, possibly contiguous reference area or control ring printed or otherwise colored or darkened to have the end point appearance of the active indicator area facilitating visual determination of the end point.

Referring again to FIG. 2, provided in righthand panel 20 of freshness certificate 10, beneath freshness indicator 50, are several rows of inspection stages 52 which are labeled with a descriptive header 54. Inspection stages 52 may be numbered or otherwise marked to correlate the freshness certificate entries with physical stages in the handling of the associated host product. To this end suitable descriptive matter may be added to freshness certificate 10, if desired. Inspection stages 52 when duly completed, as described below, provide a historical record of the exposure of freshness certificate 52 and any associated host product to a monitored ambient condition, for example temperature.

Any desired number of rows of inspection stages 52, for example from about 1 to about 8, can be employed to provide an adequate exposure history record. Some useful embodiments of the invention employ two, three, four, five, six, seven or eight rows of inspection stages 52, respectively. More rows may be employed if desired. It is envisaged that for most embodiments, no more than twelve rows of inspection stages 52 will be useful, although more could be used, if desired.

Header 54 can, as shown, bear a general legend such as “Freshness Stages” along with a column heading such as “Date and Time of Inspection”. If desired a trademark linking with, or associatable with, other proprietary material employed in freshness certificate 10, can be employed, for example “FRESH-CHECK® Stages”, FRESH-CHECK® being a trademark of TEMPTIME Corporation.

Each inspection stage 52 comprises: a freshness state legend 56 reading, e.g. “Fresh”, “Freshness Limit” or “Do Not Use”; a simulated freshness indicator 26; and a date-and-time entry box 52. The lowermost inspection stage 52 has associated with in a warning 58 bearing a message such as “After the freshness limit, do not use!”. Usefully, the center dots of simulated freshness indicators 26 are given different colors or shades to represent the different appearances actual indicator 50 will have as it experiences increasing cumulative temperature exposure. These center dots can increase in color, or darken in the downward direction as shown in panel 20, to show the attenuation of freshness that occurs with time.

These indications can be modified appropriately for maturing host products to indicate degrees of maturity or ripeness. For example, legend 56 may include readings such as “Immature”, “Maturing”, “Mature” or “Unripe”, “Ripening”, “Ripe” or other appropriate readings.

A customer or other untrained viewer can view panel 20 and readily comprehend the freshness status of the host food product as evidenced by freshness certificate 10. Any prompting the viewer might need is readily available from the facing panel, lefthand panel 18. The eye easily picks up the active indicator 50 and compares the color of its central dot with those in the column below of simulated indicators 26 to ascertain the current freshness. If the freshness limit has been reached or passed, the customer may reject the meal or other host product, and have reason to do so. Scrutiny of the data in freshness stages 52 may provide additional reason for rejection. Perhaps, for example, an undue time may have elapsed between the first and second stages.

Some embodiments of the invention can help provide quality assurance is by visually communicating to a viewer the active nature of the active indicator. When it is viewed alone for a few moments, it may be difficult for a viewer to appreciate that a color-changing indicator is in fact active if, as is probable, it undergoes no perceptible change while being viewed. However by viewing a historical record displaying past appearances of the indicator which are different from the current appearance and which are authenticated by the signature of a witness, the activity of the indicator and its current reading quickly and convincingly becomes apparent to a viewer.

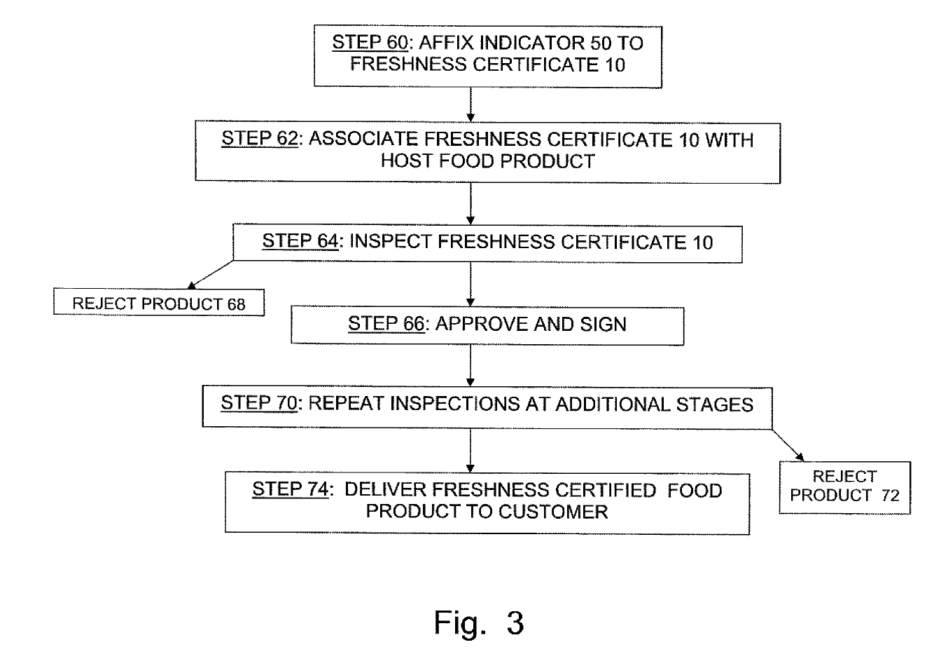

In use, in one embodiment of the invention, as illustrated in FIG. 3, at a selected point in the production and/or handling cycle of the host product, an active freshness indicator 50 is withdrawn from cold storage where any color change of its active dot or other area is minimal, and is applied to a freshness certificate 10, step 60. At this point in time, active indicator 50 is considered to be initiated. Other styles of indicator, employing different technologies, can be initiated in other ways appropriate to their technologies, for example by manual removal of an activator tab, or by use of ultraviolet light, at this point in the handling of the host product. The active indicator 50 is selected to have a response algorithm matched with, or appropriate for, the anticipated freshness attenuation characteristics of the host product.

Freshness certificate 10, with active indicator 50 affixed, is now responsive to ambient temperature fluctuations which are memorialized cumulatively as an irreversible color change, or darkening, of the active area of indicator 50.

Freshness certificate 10, with active freshness indicator 50 affixed, is promptly associated with a host product, step 62, in such a way that the host product and associated freshness certificate 10 are subsequently exposed to similar ambient temperature or other relevant conditions. For example, freshness certificate 10 can be attached to the outside of a package containing the host product or may be inserted in or within the package. The host product may be complete, or it may be partially prepared at this stage and completed at a later stage. Usefully, the active indicator 50, affixed to freshness certificate 10, is associated with the host product shortly after withdrawal from cold storage to avoid premature exposure.

The point in time at which active freshness indicator 50 is initiated is selected in accordance with the handling or other processing of the host product to be an appropriate moment at which to start the freshness clock ticking, as it were. For example, a given handler or processor of the host product may choose to initiate the indicator at a moment when a particularly perishable component of the host product is most fresh or is judged to begin to lose its freshness. In the preparation of an airline meal, this moment might, for example, be the withdrawal of a cold, or frozen, shrimp appetizer from cold storage.

At selected inspection points in the handling and/or preparation process, an inspector can inspect freshness certificate 10, step 64, making a visual comparison between active indicator 50 and the respective indicator simulation 26 corresponding with the particular inspection point. If the actual indicator 50 is no darker than the indicator simulation, the inspector certifies approval of the freshness at that station by inserting the date, and optionally the time in data entry box 52, step 66. If desired the inspector can also initial or sign data entry box 52 or another box or line (not shown), provided for the purpose. If the freshness limit for that stage has been passed, as indicated by the active area of indicator 50 being darker than depicted for that stage, the host product associated with the inspected freshness certificate 10 can be rejected, step 68.

The unique construction of righthand panel 20 of freshness certificate 10 permits multiple freshness certifications to be recorded during the handling of the host product prior to receipt thereof by a customer or other party. At one or more predetermined additional inspection stations, stages or points in time and/or space, an inspector can make additional inspections and complete the time-date stamp, step 70. Any desired number of stages may be employed, for example from two to five stages, or any other suitable number. Further products not meeting the predetermined freshness criteria, should there be any, can also be rejected, step 72. In step 74 the freshness-certified food product that results from this novel freshness monitoring and inspection process is delivered to the customer along with its freshness certificate 10.

The use of the inventive quality assurance system and novel processes according to the invention in the distribution of fresh chicken are further illustrated by the following non-limiting example.

### EXAMPLE 1

### Fresh Chicken

A stock of FRESH CHECK® time-temperature indicators 50 suitable for monitoring cumulative temperature exposure of fresh chicken is supplied by Temptime Corporation to a chicken processing facility and promptly placed into deep cold storage at about −30° C., or below. Self-adhesive, category M, substituted-diacetylene-based label-style time-temperature indicators 50 rated for 5.1 days at 8.0° C. are selected as being suitable. The indicator includes a printed reference ring having a print density and color closely matching the expected end-point appearance and color of the active indicator area at the end of the temperature exposure for which it is rated, or an equivalent thereof. The chicken processing facility slaughters live chickens, processes and packages the carcasses, and promptly moves the resultant whole chicken or chicken cuts into refrigeration, at a temperature of about 2° C. The chicken processing facility is also supplied with a stock of freshness certificates 10. A time-temperature indicator 50 is applied to a freshness certificate 10, either in a cold room or promptly at room temperature. The so-activated freshness certificate 10 is attached to a whole chicken withdrawn from refrigeration, with minimal exposure of the chicken to elevated temperatures, to preserve the freshness of the chicken. Freshness certificate 10 can be securely attached to the chicken with inspection stages 52 available for completion by human or automated means as the chicken advances to a customer's table. The certificate-bearing chicken resides in refrigeration at a temperature of 2° C., ready for shipment, for no more than one day, exposure stage 1.

The chicken is withdrawn from refrigeration, loaded onto a refrigerated truck and trucked to a retail store, exposure stage 2. At the distribution center, the chicken may reside on a loading dock or back room, for a short time at a temperature above refrigerated, exposure stage 3. It is then moved to a refrigerated display case in a shopping aisle where it remains, exposure stage 4, until selected by a customer.

The customer conveys the chicken home, or to another desired destination, by car or other means where the chicken is exposed to higher than refrigerated temperatures, exposure stage 5. The chicken then resides in the customer's destination refrigerator, exposure stage 6, until removed and cooked.

As an illustrative alternative, instead of being promptly cooked, the chicken is left in an unrefrigerated, or poorly cooled location, where it spoils, exposure stage 7. It will be understood that indicators employed in the invention, including for example indicators obtainable from Temptime Corporation can track equivalents of the idealized time and temperature stages described and are accordingly useful in a real world environment which may vary from the exemplary figures described here.

As the chicken leaves each exposure stage, freshness certificate 10 can be inspected by an appropriate individual who visually compares the appearance of indicator 50 with the appropriate simulated appearance limit for that stage. Provided the appearance limit is not exceeded, the inspector initials and dates or otherwise marks freshness certificate 10 as satisfactory at that stage. After exposure stage 6, when the customer removes the chicken from the refrigerator for cooking, they can check the appearance of indicator 50 to confirm that the chicken is still within its useful life because the inner active area of the indicator is not darker than the surrounding reference ring. If the useful life is indicated as having been exceeded, the customer may discard the chicken.

If any exposure stage appearance limit is exceeded, the freshness certificate may receive a different mark and/or the chicken may be diverted from its intended normal distribution path for discounting, for early use, for disposal, or other suitable handling. Example 1 ends here.

Variations to the above-described exposure protocol will be known or apparent to those skilled in the art. For example, the chicken may be transported by air as well as truck and/or may be shipped from the chicken processing facility to a distribution center prior to being moved on to a retail store, adding exposure stages to the protocol. The exposure protocol can be adapted to suit a variety of other distribution patterns. Such an exposure protocol can be employed to assist in the selection of a suitable active indicator component for a specific host product. It can also be employed to assist in preparing a suitable freshness certificate and in determining appropriate densities for the inspection stages 52 of the exposure history record of a freshness certificate intended for a specific host product.

Table 1, below shows some possible data exemplifying the use of freshness certificate 10 in the chicken distribution process described in Example 1.

TABLE 1
Fresh Chicken

| | | | | (E) | | (G) | | |
|---|---|---|---|---|---|---|---|---|
| | | (C) | (D) | Equivalent | (F) | Remaining | | |
| (A) | (B) | Temp | Elapsed | Days at | Cumulative | Days at | (H) | (I) |
| Exposure Stage | Days | ° C. | Time | 8.0° C. | Days | 8.0° C. | OD | Appearance |
| 0) Apply Indicator | 0.00 | | 0.00 | 0.00 | 0.00 | 5.09 | 0.23 | much lighter |
| 1) Processor refrigeration | 1.00 | 2.0 | 1.00 | 0.42 | 0.42 | 4.67 | 0.21 | much lighter |
| 2) Transport | 0.50 | 5.0 | 1.50 | 0.33 | 0.75 | 4.34 | 0.19 | much lighter |
| 3) Loading dock | 0.10 | 15.0 | 1.60 | 0.26 | 1.01 | 4.08 | 0.18 | much lighter |
| 4) Display case | 3.00 | 4.0 | 4.60 | 1.70 | 2.71 | 2.39 | 0.10 | lighter |
| 5) Consumer transport | 0.02 | 25.0 | 4.62 | 0.19 | 2.90 | 2.20 | 0.09 | lighter |
| 6) Consumer refrigerator | 4.00 | 4.0 | 8.62 | 2.26 | 5.16 | −0.07 | 0.00 | similar |
| 7) Spoilage | 4.00 | 6.0 | 12.62 | 3.02 | 8.18 | −3.08 | −0.11 | darker |

Referring to Table 1, the various exposure stages are listed in column A. Columns B and C show the actual time and temperature for each exposure stage. Column D shows the total elapsed time. Column E shows the elapsed time, at each stage, in days-equivalent at a temperature of 8° C. Column F shows the cumulative time in days-equivalent at a temperature of 8° C. Column G shows the remaining days in days-equivalent at a temperature of 8° C. Column H gives a differential value for the extent to which the indicator active area is visually different from the reference ring at the end of the exposure stage indicated in column A, in terms of an arbitrary scale of reflective optical density readings. A positive number in Column H means the indicator is lighter than the reference ring and has not reached its pre-set exposure limit. A negative number means the indicator is darker than the reference ring and has exceeded its pre-set exposure limit. Column I provides a qualitative description of the visual appearance of the active indicator area versus the reference ring.

The time periods in column B describe reasonable intervals in which the chicken may be exposed to the temperature indicated in column C without impairing the usability of the chicken when it reaches the consumer. As may be read from columns H and I, the active indicator remains visually lighter than the freshness or usability limit indicated by the color of the reference ring, throughout exposure stages 1-5. At the end of stage 6, after four days in the consumer's refrigerator, there is no difference in visual intensity between the active area and the reference ring, indicating that the freshness limit has been reached and the chicken should be promptly cooked. At the end of exposure stage 7, four days at 10° C., the active area is darker than the reference area indicating that the chicken may be spoiled and should be carefully inspected or discarded.

The inventive quality assurance system can also usefully be applied to the preparation of food service meals for an organization, for example an airline. The several inspection points may, in one example, be selected to be at any of various stages in the preparation of an airline meal, such as the well-known three- or four-course meal delivered on a tray. Such meals may include one or more of a salad or hot or cold appetizer, a hot, oven-cooked entrée, a cold dessert, optional items such as cheese, jams, jellies, cream, chocolate, bread, butter and so on assembled on a tray, optionally under a cover which may be transparent or opaque. Some alternatives include cold entrées and hot desserts. Commonly, a full three- or four-course meal may be assembled on a single tray and may comprise an appetizer, entrée and dessert, optionally with cheese, or equivalents of these courses. Alternatively, or in addition, the meal may comprise hot or cold snacks and/or sandwiches. The meal components can optionally be wrapped in foil, plastic, paper or other suitable packaging material. Fresh fruit, for example an apple, orange or banana, bread rolls or other suitable products may be unwrapped. Many possible variations of the meal components will be, or become, known to, or apparent to, those skilled in the art.

Food service embodiments of the invention can be employed not only by airlines, but also by other entities having facilities to serve a food consuming population. Such entities include cafeterias, restaurants, caterers, residential institutions, governmental facilities, corporations, nursing homes, schools, boats, ships, trains, food delivery services and other food service facilities.

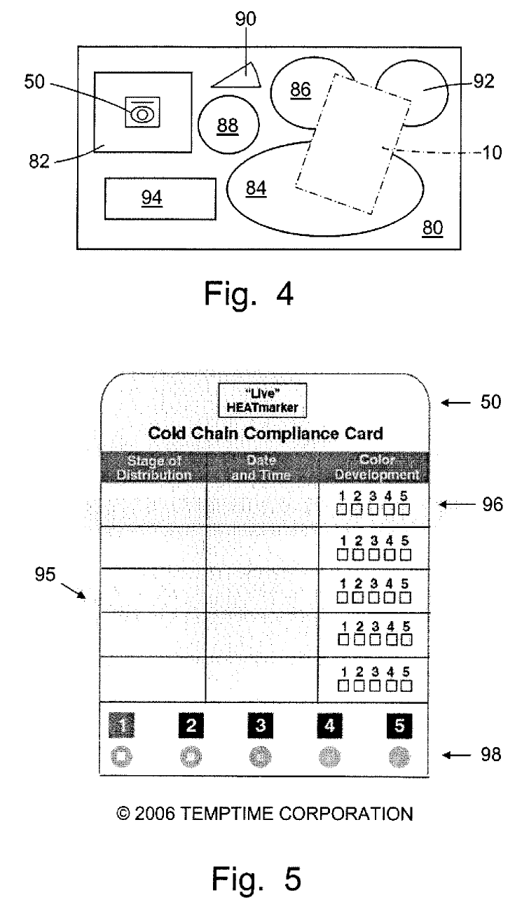

Referring now to FIG. 4, the airline meal shown comprises a tray 80 on which are assembled a number of meal components. Exemplary meal components shown comprise an appetizer 82, an entrée 84, a dessert 86, a bread roll 88, cheese 90, a beverage cup 92 and a utensil-and-condiment pack 94.

The freshness quality of the various food ingredients of the airline meal is assured by means of a quality assurance system comprising a freshness certificate 10 and a freshness indicator 50. Freshness certificate 10 is shown overlaid on entrée 84, dessert 86 and beverage cup 92 where it will greet, surprise and intrigue the customer. Freshness certificate 10 may include a description of the meal preparation process and the role of the freshness certificate. If desired, freshness certificate 10 may be removably adhered, taped, tied, clipped or otherwise attached to tray 80 or one of the meal components. Freshness indicator 50 is adhered to a plastic transparent film covering appetizer 82 and has a response algorithm correlated with the temperature perishability characteristics of one of the more perishable food tray items, for example a cold shrimp appetizer, should that be employed. Freshness certificate 10 provides a historical record of the temperature exposure of the airline meal during preparation, employing data obtained from indicator 50 by inspection of same at appropriate stages as described herein. The presence of indicator 50, freshness certificate 10 and the history record it contains can be combined to give the customer a unique sense of the freshness quality of the meal before them and of the careful preparation it has received.

The trays can be assembled in a central kitchen with generous refrigeration capabilities, held in central storage in or associated with the kitchen and then transferred to the airline. After assembly, the trays are moved through the airport and loaded on to an aircraft at the gate. Typically, they are stored in refrigerated bays on board until served. Oven-cooked entrées and the like may be handled separately and delivered to passengers after they have received trays and may have a separate freshness certificate, if desired. Freshness indicator 50 can for example be initiated as the food service tray is being assembled. If a cover is employed for the meal tray, freshness certificate 10 may be placed under the cover or attached to the outside of the cover. Where no cover is employed, freshness certificate 10 may simply be placed on the tray or may be temporarily or removably attached to the meal tray or a tray component.

In another embodiment of the invention, freshness indicator 50 is a separate tag or label which is attached to, or otherwise associated in close proximity with, the food tray, or one of the ingredients of the food tray. For example, freshness indicator 50 may comprise an adhesive label attached to the food-bearing surface of the tray where it will be seen to have experienced similar exposure to ambient conditions to food products on the food tray. Alternatively, freshness certificate 10 may be adhered to a wrapped meal component. As a further alternative, freshness indicator 50 may be adhered to an unwrapped meal component, for example an apple. Multiple freshness indicators 50 may be employed for a single food tray, or food service package or product, if desired to provide an additional level of quality assurance. Different freshness indicators 50 can be attached to, or otherwise associated with, different meal components.

Embodiments of the quality assurance system of the invention include a food service tray or other food service package or assembly together with an accompanying freshness certificate 10 or other freshness document including a freshness indicator 50 closely associated with the food service product. Freshness indicator 50 can be either separately associated with the food service product or may be an integral element of freshness certificate 10 which is closely associated with the food service product, for example by being supported on the food service tray, optionally under a cover for the tray, if employed. In one embodiment, freshness indicator 50 is removably attached to freshness certificate.

If desired, where freshness indicator 50 is separate from, or separable from, freshness certificate 10, each may bear a common identifier to relate freshness certificate 10 to freshness indicator 50. In this way, a customer or other inspector or viewer may know that the food service meal or other product indicated as fresh by the closely associated freshness indicator 50 has the history shown by the inspection stages 52 in the history record of the corresponding freshness certificate 10.

Freshness inspections can for example be made on delivery into central kitchen storage, on retrieval therefrom, on receipt by the airline or their agent, on receipt by the aircraft and/or immediately prior to service to the airline passenger. Appropriate entries regarding the outcomes of the inspections can be entered in freshness stages 52 which can additionally, if desired, bear text and/or iconic legends (not shown) descriptive of the point in the food handling process where the inspection is made.

In this or other suitable manner, freshness certificate 10 can be employed to validate the freshness of the whole airline meal and/or its most sensitive ingredient or component.

In a further embodiment of the invention, an airline oven-cooked meal can have a freshness certificate 10 integrated therewith and presented with the meal to the passenger or other customer. The freshness certificate may track the pre-oven preparations stages of the oven-cooked meal, for example, withdrawal of raw ingredients from freezer or cold storage, assembly into the cooking dish, centralized refrigeration of the assembled dish, distribution of the dish to an aircraft or other destination, holding in the aircraft bay prior to cooking and so on. Of course freshness certificate 10 does not go into the oven and furthermore, it will usually be desirable to separate freshness certificate 10 from the cooked meal or other product, to avoid inappropriate heat exposure of indicator 50. Desirably, indicator 50 can be formed of materials that do not generate harmful products if inadvertently “cooked” in the oven with the meal. Substituted diacetylenic monomers can be useful active indicator components for this purpose.

A further embodiment of the invention marks the oven-cooked dish with a unique identifier and employs the same identifier on a particular freshness indicator 50 or freshness certificate 10 used to track the cold history of that specific oven-cooked dish. The freshness certificate 10 and cooked dish are separated for cooking and then reunited immediately before, or during, service to the customer who may then match identifiers to confirm the freshness of the oven-cooked dish.

The use of the inventive quality assurance system and novel processes according to the invention in airline food service are further illustrated by the following non-limiting example.

### EXAMPLE 2

### Airline Food Service

Following the procedure of Example 1, a stock of FRESH CHECK® time-temperature indicators 50 suitable for monitoring cumulative temperature exposure of an airline meal from tray assembly to service is supplied by Temptime Corporation to an airline food service facility. Indicators 50 are promptly placed into deep cold storage at about −30° C., or below. Self-adhesive label-style, category B, substituted-diacetylene-based time-temperature indicators 50 rated for 3.4 days at 8.0° C. are selected as being suitable. Each indicator 50 includes a printed reference ring having a print density and color closely matching the expected end-point appearance and color of the active indicator area at the end of the temperature exposure for which it is rated, or after an equivalent exposure.

Indicators 50 are withdrawn from deep cold storage at about the same time as fresh temperature-sensitive meal components are made ready for assembly into trays, exposure stage 0. Indicators 50 are applied one each to wrapped bread roll for each of a batch of meals being assembled. During the assembly, the food product is exposed to a temperature of about 12° C. for no more than 30 minutes, exposure stage 1. The meal trays each with freshness indicator 50 attached are moved to intermediate cold storage for up to about 9.5 hours at 4° C., exposure stage 2. The meal trays with freshness indicator 50 attached are then removed from intermediate storage and placed in a tray assembly area for up to 30 minutes at about 14° C. to complete assembly of the meal components on to the tray, exposure stage 3. After assembly, the meal trays are moved from tray assembly to a final holding bay for up to 18 hours at 4° C., until required by an aircraft, exposure stage 4. Once requisitioned, or pursuant to a schedule, the meal trays are transferred from the final holding bay to a departure platform where they wait for up to about 2.5 hours at about 15° C., exposure stage 5. When the aircraft is ready, the meal trays are then loaded onto the aircraft, at about 25° C. taking up to about 30 minutes, exposure stage 6. On the aircraft, the meal trays, with freshness indicator 50 attached, are placed into an airplane trolley and held for up to 5 hours at 5° C., until the meal is served to passengers, exposure stage 7.

Table 2, below, shows some possible data exemplifying the use of freshness certificate 10 in the airline meal preparation process described in Example 2.

TABLE 2
Airline

| | | | | (E) | | (G) | | |
|---|---|---|---|---|---|---|---|---|
| | | (C) | (D) | Equivalent | (F) | Remaining | | |
| (A) | (B) | Temp | Elapsed | Days at | Cumulative | Days at | (H) | (I) |
| Exposure Stage | Days | ° C. | Time | 8.0° C. | Days | 8.0° C. | OD | Appearance |
| 0) Make ready | 0.00 | | 0.00 | 0.00 | 0.00 | 3.40 | 0.23 | much lighter |
| 1) Tray assembly | 0.02 | 12.0 | 0.02 | 0.03 | 0.03 | 3.36 | 0.23 | much lighter |
| 2) Intermediate storage | 0.40 | 4.0 | 0.42 | 0.23 | 0.26 | 3.14 | 0.21 | much lighter |
| 3) Tray assembly area | 0.02 | 14.0 | 0.44 | 0.05 | 0.31 | 3.09 | 0.21 | much lighter |
| 4) Final holding bay | 0.80 | 4.0 | 1.24 | 0.45 | 0.76 | 2.64 | 0.17 | lighter |
| 5) Departure platform | 0.10 | 15.0 | 1.34 | 0.26 | 1.02 | 2.38 | 0.15 | lighter |
| 6) Loading onto aircraft | 0.02 | 25.0 | 1.36 | 0.19 | 1.21 | 2.19 | 0.14 | lighter |
| 7) Aircraft trolley | 0.20 | 5.0 | 1.56 | 0.13 | 1.34 | 2.06 | 0.13 | lighter |

Referring now to Table 2, the data columns have the same meanings as in Table 1. It may be seen from columns H and I that pursuant to the protocol described in Example 2, are shown by indicators 50 to be comfortably within their freshness limits when served to airline customers. A meal that for some reason displays a center indicator area which is darker than its reference ring can be discarded or otherwise handled differently. Example 2 ends here.

### EXAMPLE 3

### Airline Food Service with Freshness Certificates

Example 2 is repeated with the difference that freshness certificates 10 each bearing an indicator 50 are included, one to each, with one or more other food components on the food trays in exposure stage 0. Freshness certificates 10 each have eight inspection stages corresponding with exposure stages 0-7. At the transition from one exposure stage to the next, each freshness certificate 10 is inspected, initialed, or otherwise marked, dated and timed In the event that indicator 50 shows an exposure beyond the limit for a given stage, the respective food tray is diverted from normal processing and handled accordingly.

### EXAMPLE 4

### Airline Food Service with Freshness Indicators

Example 3 is repeated with the difference that, through stages 1-6, freshness indicators 10 are included on the food trays on their own without freshness certificates 10. Freshness certificates 10 are provided to customers only at stage 7. Identifying data are used to correlate each freshness indicator 50 with a respective freshness certificate.

Further embodiments of the invention can employ similar or comparable measures to certify or validate the freshness of meals served by institutions, cafeterias, food delivery services and the like.

Other food products to which the invention can be applied include food service products, including restaurant service, fresh cut foods, including fruits, salads and the like, mail order or public carrier delivery products such as gourmet and other fruits, chocolates, cheeses, fresh and cured meats, chicken, fowl, game, and the like, and ready-to-eat or ready-to-cook meals ordered by phone, mail or Internet and delivered to a residence or business. Such products will gain quality benefits, provide increased customer satisfaction and brand prestige and have added value permitting premium pricing by employing the inventive freshness certificate described herein.

While the freshness certificate shown is particularly well suited for use with host products delivered to consumers and other customers, other versions may be employed. For example a double-sided card or equivalent label suitable for tying or otherwise affixing to commercial or industrial cartons could simply employ interior panels 18 and 20 or variations thereof. A simple, single-page freshness tracking product can be provided, pursuant to the invention by a device such as constituted by righthand panel 20 of freshness certificate 10.

The invention also provides an active cold-chain compliance monitor which in one embodiment can take the form of a card such as is illustrated in FIG. 5.

Referring to FIG. 5, the embodiment of cold chain compliance tracking card illustrated is a single-sided card 95 which has at the top of card 95, above the card title, an area marked ‘“Live” HEATmarker’ designed to receive a self-adhesive label-style active time-temperature indicator 50 withdrawn from deep cold storage at the commencement of monitoring. As indicated herein, “HEATmarker” is a registered trademark of Temptime Corporation.

Beneath the card title is a record area comprising three data columns which is intended for completion by one or more human inspectors of the cold chain compliance card 95. In conjunction with visual inspection of indicator 50, the inspector provides descriptive information regarding the stage of distribution, the date and time of inspection and the degree of color development of indicator 50. The columns are divided into stage record rows across the card each of which stage record rows correlates with a distribution stage such as a facility or a transport vehicle. An exemplary record row 96 has blank boxes for manual or machine entry of the distribution stage information and the date and time. The color development column is provided with five check boxes, one of which is selected and checked according to the appearance of indicator 50, at the respective distribution stage. An indicator appearance scale 98 comprising five numbered simulations of different exposures of indicator 50, is provided at the foot of the cold chain compliance card 95 to enable an inspector readily to select an appropriate check box.

Indicator appearance scale 98 is one example of a visual scale that may be employed for describing the appearance of time-temperature indicator 50. Such a visual scale can comprise multiple visual simulations of the appearance of time-temperature indicator 50 at different degrees of cumulative temperature exposure. The numbers from 1 to 5 serve as notations for referencing the visual simulations, the compliance record providing for each stage record 96 check boxes to select a suitable notation indicative of the appropriate one of said visual simulations.

As is illustrated in FIG. 5, and is described elsewhere herein, each visual simulation can have an indicator area and a reference area adjacent the indicator area. The reference area has a visual appearance corresponding with the appearance of the time-temperature indicator at a cumulative temperature exposure limit and helps a viewer quickly interpret the appearance of the active indicator area.

In the illustrated embodiment of the invention, five rows 98 are provided for up to five inspection stages. Different numbers of rows, for example from about 2 to about 20, may be provided, as desired.

A simple example of a completed cold chain compliance card 95 has supplier, distribution and end user storage stages plus two transportation stages. The color development of indicator 50 advances evenly for each stage with the respective boxes 1, 2, 3, 4 and 5 being checked for each stage. At the end of the fifth stage which is the end-user storage stage, the desired cold storage limit is reached as indicated by matching of the indicator area appearance with that of the reference ring.

By appropriate selection of the characteristics of integrated time-temperature indicator 50, cold chain compliance card 95, or distribution temperature monitor can be used to monitor distribution chains subject to room temperature standards, for example drugs or munitions, or to monitor another temperature regimen.

The cold-storage chain monitoring system embodiment provided by the card shown in FIG. 5 is easy to complete accurately and reliably and solves problems of known monitors which may be confusing or difficult to use.

The active indicator component employed in indicator 50 utilized in the cold chain compliance card 95 shown in FIG. 5 does not need to be matched to a host product. Rather the indicator algorithm is selected to be useful for tracking whether the cold chain environment to which a heat-sensitive product is exposed meets regulatory requirements regarding cold storage. For example, the indicator component may be a substituted color-changing diacetylenic agent rated for 21 days at 12° C. or equivalent. Unlike known cold storage monitors, which record excursions above thresholds, the cold chain compliance card 95 shown provides a record of integrated temperature exposure throughout the range experienced by the compliance card. Accordingly, exposures of excessive duration at compliant temperatures, which may not be recognized by known devices but could conceivably be detrimental, can also be monitored.

The invention includes data logging and storage aspects. The data collected or made possible by the quality assurance system of the invention, and its various embodiments can be input to one or more computerized data managements systems and processed as desired. For example, each completed freshness document 10, or cold chain compliance monitor 95, in a batch or batches, can be imaged or the data it contains can be optically read or manually read and keyed or spoken into a computer system. A web-based program can be employed, if desired, for convenient access by a number of users.

If desired, an imaged document 10 or 95 can be displayed on a computer screen, with a color comparison chart to facilitate reading of active indicator 50, and employing a touch screen or a keypad data would be captured into a computer system for archive and analysis. Such computerized data entry of quality-related data displayed on quality assurance document 10 or 50 can be effected at one or more stages in the distribution or preparation of a host product, if desired, to provide statistical data regarding the time-related temperature exposure profile of a given host product as it is distributed or prepared. In this way a novel body of data regarding the handling, responses and probable condition of one or many host products can readily be generated and utilized for quality control, verification, audit, analysis, forecasting and other purposes.

Embodiments of the quality assurance system of the invention can usefully be employed to assure the freshness of a wide range of perishable products, including for example:
foodstuffs, some examples of which are: fruit, vegetables, dairy products, for example milk, cream, yogurt and cheese; eggs and egg-containing products; baked products, for example, breads, cakes, cookies, biscuits, pastries and pies; fresh, cooked, cured or smoked meats and fish; and roasts, steaks, chops, and whole and split carcasses of beef, veal pork, lamb, goat, game, domesticated meat, wild meat and other meat;
food service products, for example restaurant service foods, fresh cut foods, fruits, salads and the like;
mail order supplied or public carrier delivery products for example gourmet and other fruits, chocolates, cheeses, fresh and cured meats, chicken, fowl, game, and the like, and ready-to-eat or ready-to-cook meals ordered by phone, mail or Internet and delivered to a residence or business;
perishable animal foods for example pet foods and foods for agricultural, zoological or other animals;
food additives, for example aspartame;
cut and uncut flowers;
cosmetics, for example cosmetics containing biologicals or other labile ingredients;
beauty aids;
biological materials for industrial or therapeutic uses, for example cultures, organs and other human or animal body parts, blood and perishable blood products;
diagnostic devices, kits and ingredients containing perishables;
perishable health care products, for example vaccines, drugs, medicaments, pharmaceuticals, medical devices and prophylactics;
perishable munitions and ordnance including munitions and ordnance prone to become unstable in response to exposure to an ambient condition, for example a shell, bullet, mine, bomb, torpedo, warhead, a package of solid, semisolid, plastic or liquid explosive and detonators;
perishable skin decontamination packs and products intended to remove or neutralize chemical warfare or toxins from the skin;
perishable chemical or biological agent detection kits useful for detecting exposure to nerve agents, blood agents, blister agents, or other toxic agents;
perishable photographic supplies;
perishable chemicals and industrial supplies, for example solder paste; and
other monitorable perishable products as will be apparent to those skilled in the art. The invention includes quality assured perishable products comprising any of the herein described perishable host products provided with a quality assurance system according to the invention described herein.

Embodiments of the quality assurance system of the invention can also usefully be employed to assure the maturity of a wide range of maturable products, including for example:
one or more maturing consumable products selected from the group consisting of: fruits; apples; pears; kiwis; melons; grapes; grapefruit; bananas; peaches; nectarines; plums; pineapples; mangoes; guavas; dates; papayas; plantain; avocadoes; peppers; tomatoes; cheeses; soft cheese; brie cheese; camembert cheese; hard cheese; cheddar cheese; aging beef; aging steak; other aging meats and meat products; aging gourmet meats; gourmet hams; pheasant; gourmet game products; aging sausages; wines; Bordeaux wine, burgundy wine; claret; champagne; port; whisky; cognac; beverages that can benefit from maturation; and maturing consumable products lacking an inherent visual indication of maturity.

The invention furthermore includes quality assured maturable or maturing products comprising any of the herein described maturable host products provided with a quality assurance system according to the invention described herein.

The use of ambient condition indicators for monitoring the condition of maturing consumable products is described and claimed in U.S. patent application Ser. No. 11/119,650 filed May 2, 2005, having first inventor Prusik and entitled “Method Of Marketing Maturing Consumable Products And Products Useful Therein”, the entire disclosure of which is incorporated by reference herein.

Other Time-Temperature Indicator Technologies. Alternatively, a variety of other indicator technologies that are cumulatively responsive to exposure to ambient or environmental conditions, for example temperature fluctuations, is available and can be employed in the practice of the present invention, if desired, as will be apparent to those skilled in the art. For example, diffusion technology such as is disclosed in a number of patent publications assigned to 3M Innovative Properties Company, for example Arens U.S. Pat. No. 5,667,303; Spevacek U.S. Pat. No. 6,614,728; Bommarito, et al. U.S. Pat. No. 6,741,523; Spevacek US Patent Publication No. 20030053377; and others may be employed.

Thus, for example, Arens et al. discloses time-temperature indicators, some of which require mechanical activation, that employ the migration or diffusion of a viscoelastic material, e.g. an adhesive into a substrate to change the light transmissivity of the substrate, to provide an indication of the expiry of the useful life of foods and other perishable products.

Some further indicator technologies that may be employed in the practice of the present invention are described in the following paragraphs. Others will be, or will become, apparent to those skilled in the art.

Yanagi, et al U.S. Pat. No. 5,756,356 assigned to Toyo Ink discloses a method of indicating a temperature-time accumulated value as a color change wherein an oxidation-polymerizable dyestuff and an oxidizing agent are brought into contact with each other.

Lupton et al. U.S. Pat. No. 5,622,137 assigned to Trans World Services discloses use of a colored thermochromic material obscuring a patch of another color, that melts and becomes transparent when exposed to a predetermined temperature. Lupton et al. lists a number of patents and other publications describing time-temperature indicators, which listing is hereby incorporated herein along with the disclosures of each patent or other publication listed by Lupton et al. Each patent there mentioned is hereby incorporated herein by this specific reference thereto.

Manico et al. U.S. Pat. No. 6,043,021 assigned to Eastman Kodak Company discloses a time and temperature integrating indicator device having a thermally sensitive image-forming area which comprises a combination of an organic silver salt oxidizing agent and a reducing agent monitoring thermal exposure of photographic material. As well as the combination indicator disclosed in U.S. Pat. No. 6,757,492, described above, other patents assigned to Eastman Kodak Company, for example U.S. Pat. Nos. 6,514,462; 6,214,623 and 6,113,857, disclose various time-temperature and other condition monitoring indicators that may be useful in the practice of the present invention.

FreshPoint Quality Assurance Ltd. discloses on their web site possible use of a time temperature indicator to provide a visual reading of product freshness, employing thermosensitive organic crystals that lose color when exposed to temperatures above a predetermined level. An active matrix incorporating the organic crystals is exposed to UV light to cause color development and then encapsulated in transparent UV-blocking plastic foil. The active matrix decay length can be varied by modifying the UV dosage. Reportedly, the indicator can be incorporated in a product's package as a sticker or embedded in the printing of the package. Related technology which could be employed in the present invention, as could be determined by one skilled in the art, is disclosed in Haarer and Eichen International Patent Publication No. WO99/39197. The Freshpoint and Haarer technologies could be employed in the practice of the present invention, if desired, notwithstanding the apparent drawbacks of requiring initiation by potentially hazardous ultraviolet light and use of a non-intuitive dark-to-light technology.

Also, Sjoholm, et al. disclose in U.S. Pat. No. 6,642,016 assigned to Bioett AB, describe an enzyme-based sensor which activates an antenna operating on swept RF which reportedly can sense and report environmental data. Agerhem, et al. U.S. Pat. No. 4,284,719, assigned to Kockums Chemical AB, discloses an enzymatic time-temperature indicating device employing a rupturable partition. Such enzyme-based indicators can be employed if they meet, or can be adapted to meet the objectives of the present invention, without undue experimentation.

And Zweig US Patent Publication No. 20040212509 discloses electronic time-temperature indicators with a visual output that can be employed to monitor the thermal history of a complex material.

Other proposed time-temperature indicating devices include: pH-indicator devices from Avery Dennison; microbiological devices from Cryolog; enzyme-based pH change devices from Vitsab; and a visible time-temperature indicating device employing a silver salt redox reaction. Those skilled in the art may select any suitable ones of the foregoing time-temperature indicators, or other known time-temperature indicators, pursuant to the teachings herein, and adapt same by suitable matching, by selection, adjustment, programming or other means to desired host product characteristics, and suitable incorporation into host product devices and manufacturing and/or marketing methods, to provide useful indications of the incipient or actual maturity of maturing consumable products employing methods and/or devices of the invention such as are described herein.

Low-Temperature Spoilage Indicator. If desired, a freeze indicator or other low-temperature spoilage indicator may be employed in combination with the described time-temperature indicator, as has been referenced hereinabove, to indicate past exposure to an excessively low temperature which could compromise host product quality. This combination of indicators can give a highly informative indication of the temperature exposure history and thence not only of the freshness or maturity of the host product, but also of the condition and quality of a particular foodstuff, or other host product, especially, for example, of frost-sensitive products such as soft fruits. If desired, freshness certificate 10 could include such a low-temperature spoilage indicator in addition to active freshness indicator 50, which could also be affixed to righthand panel 20, or could be placed in another suitable location. One skilled in the art may select a suitable freeze indicator for use in a combination freshness and condition indicator, pursuant to the teachings of the invention herein from a wide variety of technologies, if desired.

For example, Ignacio, et al. U.S. Pat. No. 5,239,942, assigned to Pymah Corporation, discloses a freeze indicator comprising a frangible ampoule which is rupturable to release a dye that provides a color change. Shahinpoor U.S. Pat. No. 6,837,620, assigned to JP Labs, Inc., discloses a shape memory alloy temperature sensor having an alloy element that changes shape when exposed, even temporarily, to temperatures below a particular start temperature to provide a persistent indication of the temperature exposure. And Patel U.S. Pat. No. 6,472,214 discloses a freeze monitoring device comprising a color changing indicator, which may be a partially polymerized diacetylene which can undergo an irreversible color change, e.g., from blue to red, when the activator mixture is frozen in the region of about 0 to −30° C.

Other low-temperature threshold and freeze indicator devices and methods from which a suitable device or method for employment in the present invention may be selected are known to the art and some are disclosed in U.S. Pat. Nos. 5,111,768; 4,191,125; 5,215,378; 4,457,253; 4,148,748; 4,846,095; 2,971,852; and 4,028,944.

Excess Temperature Exposure Indicator. If desired, an excess temperature exposure indicator, which indicates the past occurrence of exposure to a temperature above a threshold temperature may be employed in combination with the described time-temperature indicator, referenced hereinabove, to give further information of a host product's temperature exposure history. Such information can be useful to indicate whether the handling of a product has met prescribed requirements, for example government regulations, or for other purposes. Such excess temperature exposures even if brief, may compromise the quality or safety of a product. Furthermore, freshness certificate 10 could include such an in addition to active freshness indicator 50, which could also be affixed to righthand panel 20, or could be placed in another suitable location. One skilled in the art may select a suitable excess temperature exposure indicator for use in a quality assurance system, pursuant to the teachings of the invention herein from a wide variety of technologies, if desired. For example, U.S. Pat. No. 5,709,472 (Prusik); U.S. Pat. No. 3,954,011 (Manske); U.S. Pat. No. 5,120,137 (Ou-Yang) and U.S. Pat. No. 5,368,905 (Ohno) disclose excess temperature exposure indicators which can be employed. Also, if desired, a low-temperature spoilage indicator, as described above may be included to provide a comprehensive quality assurance system which can effectively communicate the cumulative temperature history of a host product, whether the product has been handled pursuant to requirements and whether it has suffered undue low-temperature exposure.

Other Freshness- and Maturity-related Parameters. While the invention has been described above in relation to the monitoring of cumulative ambient temperature fluctuations as a marker for freshness, one or more of various other freshness-related parameters or conditions can be monitored, if desired, as an alternative to, or in combination with, cumulative time-temperature monitoring. The value or values of such other parameters can be indicated visually, as described herein. Desirably the indicator technology employed utilizes a response algorithm or algorithms which provide a simple visual indication of freshness.

For example, the visual environmental condition indicator may be responsive to an environmental condition selected from the group consisting of: cumulative humidity exposure over time; cumulative concentration exposure over time to a maturity-affecting externally applied gaseous agent; cumulative concentration exposure over time of a carbon-dioxide sensitive consumable product to externally applied carbon dioxide; and cumulative concentration exposure over time of apples, pears, or other suitably responsive fruit, to externally applied ethylene. The gaseous agent may itself be an indicator of freshness and may for example be a gaseous product released by the host product as its freshness declines. Such gas can be produced as a result of microbial action, for example a low-molecular weight amine released from a proteinaceous host product, e.g. fish or meat which may indicate spoilage. Some indicators for detecting food spoilage by employing an amine-responsive compound and which may be employed in the practice of the invention are described in Williams United States Patent Application Publication No. 2005/0153452.

Other ripeness or maturity tracking indicators which can be employed in the practice of the present invention include: Mark Riley's “RediRipe” ripeness-indicating stickers as described in a USA Today article posted to the Internet on Jul. 27, 2006; and RIPESENSE™ ripeness sensors developed by HortResearch (New Zealand) and the Jenkins Group (New Zealand), as described in Growing Futures Case Study #19. Convenience Foods, Martech Consulting Group, (publication date unknown).

While the invention has been described in terms of products intended for human consumption, it will be understood that the consumable products employed in practicing the invention may be intended for animal rather than human consumption, if desired.

Disclosures Incorporated. The entire disclosure of each and every United States patent and patent application, each foreign and international patent publication, of each other publication and of each unpublished patent application that is referenced in this specification or elsewhere in this patent application, is hereby incorporated herein, in its entirety, by the respective specific reference that has been made thereto.

The foregoing detailed description is to be read in light of and in combination with the preceding background and invention summary descriptions wherein partial or complete information regarding possible embodiments of the invention may be set forth and where modifications, alternative and useful embodiments of the invention may be suggested or set forth, as will be apparent to one skilled in the art. Should there appear to be conflict between the meaning of a term as used in the written description in this specification and the usage in material incorporated by reference from another document, the usage herein is intended to prevail.

It is anticipated that other embodiments and variations of the present invention will become readily apparent to the skilled artisan in the light of the foregoing description and examples, and such embodiments and variations are intended to likewise be included within the scope of the invention which is defined in the appended claims.

1. A quality assurance system for assuring the quality of an associated specific host product, the quality of the host product being time related to exposure to an ambient condition, wherein the quality assurance system comprises:
(a) an ambient condition indicator for providing a current visual indication of the cumulative exposure over time of the host product to the ambient condition wherein the ambient condition indicator has an active component selected to provide a visual response to the ambient condition in a manner correlated with the response characteristics of the specific host product to the ambient condition; and
(b) a historical record providing at least one historical visual indication of cumulative exposure over time of the host product to the ambient condition at a prior point in time;
and wherein the quality assurance system communicates to a human viewer a verified data signal regarding the ambient condition-related quality of the host product the verified data signal comprising the current visual indication and the at least one historical visual indication of the cumulative exposure over time of the host product to the ambient condition.

2. A quality assurance system according to claim 1 wherein the host product comprises multiple product items and the quality assurance system comprises one of the ambient condition monitors for each host product item.

3. A quality assurance system according to claim 2 wherein the ambient condition indicator and the historical record each have an indicator area and a reference area adjacent the indicator area, wherein the reference area has a visual appearance corresponding with the appearance of the ambient condition indicator at a limit of exposure to the ambient condition.

4. A quality assurance system according to claim 3 wherein the ambient condition indicator has an indicator area and wherein the indicator active component occupies the entire indicator area and darkens or lightens the appearance of the entire indicator area in response to exposure to the ambient condition.

5. A quality assurance system according to claim 1 wherein the ambient condition is temperature and the indicator active component is chemically active to provide the visual response and is continuously responsive to ambient temperatures, being active when withdrawn from low temperature storage.

6. A quality assurance system according to claim 1 wherein the condition indicator active component is continuously responsive to temperatures within a range of from about −20° C. to about 60° C.

7. A quality assurance system according to claim 1 wherein the quality assurance system comprises a quality assurance document including the historical record and wherein the ambient condition indicator is associated with the host product to monitor exposure of the host product to the ambient condition.

8. A quality assurance system according to claim 1 wherein the quality assurance system comprises a quality assurance document, the quality assurance document including the historical record and the ambient condition indicator and wherein the quality assurance document is associated with the host product to monitor exposure of the host product to the ambient condition.

9. A quality assurance system according to claim 8 wherein the ambient condition indicator, including the active indicator component, is printed on the quality assurance document.

10. A quality assurance system according to claim 3 wherein the host product item is selected from the group consisting of an individual host product package, a food service meal, a food package intended for delivery by common carrier, a package containing not more than ten similar articles, a vaccine vial, a kit for performing a service and a package of shaped or amorphous solid, semi-solid or liquid material.

11. A quality assurance system according to claim 1 wherein the quality assurance system comprises a quality assurance document and the quality assurance document includes at least one graphic appearance element facilitating comprehension of the information conveyed by the ambient condition indicator and the historical record.

12. A quality assurance system according to claim 1 wherein the assured specific host product quality is freshness or maturity and the quality assurance system communicates to a viewer verified data regarding the respective freshness or maturity of the host product.

13. A quality assurance system according to claim 1 wherein the quality assurance system comprises a quality assurance document and the quality assurance document comprises multiple graphic design elements giving the quality assurance document an aesthetically appealing visual appearance.

14. A quality assurance system according to claim 13 wherein the graphic design elements comprise at least one simulation of the ambient condition indicator in a stage of partial exposure to the ambient condition and optionally wherein the simulation is labeled with a corresponding degree of the host product condition.

15. A quality assurance system according to claim 1 wherein the quality assurance system comprises a quality assurance document and the quality assurance document comprises multiple visual design elements cooperative to simulate an official certificate or authorization, optionally a travel document.

16. A quality assurance system according to claim 1 wherein the specific host product comprises a food service meal, the quality assurance system comprises a quality assurance document and the quality assurance document comprises a cover openable to display an inside surface and comprises multiple stamps, dates and/or signatures applied as original marks to a specific document associated with a specific food service meal to verify compliance with a predetermined freshness standard at each of multiple time points in the life of the food service meal prior to service of the food service meal to a customer.

17. A quality assurance system according to claim 1 wherein the historical record comprises multiple historical visual indications and each historical record visually indicates a prior freshness condition at a point in time stated in the historical record.

18. A quality assurance system according to claim 1 wherein the quality assurance system comprises a quality assurance document and the quality assurance document comprises a bifold sheet of a size and configuration permitting the quality assurance document to be handheld and read.

19. A quality assurance system according to claim 18 wherein the quality assurance document comprises an outside cover, the outside cover having a front panel and a back panel and comprises an interior the interior having a lefthand panel and a righthand panel.

20. A quality assurance system according to claim 19 wherein the front panel bears a simulated freshness indicator and, optionally, a freshness message to convey the function of the quality assurance document.

21. A quality assurance system according to claim 19 wherein the host product is an airline meal and the front cover comprises a graphic depiction of the world.

22. A quality assurance system according to claim 1 wherein the quality assurance system comprises a quality assurance document and the quality assurance document is formed of card, plastic or heavy duty paper or a combination of two or more of card, plastic and heavy duty paper.

23. A quality assurance system according to claim 22 wherein the quality assurance document comprises a hinge between the panels enabling the lefthand panel to be folded over the righthand panel, wherein the panels are rectangular and the quality assurance document simulates a travel document.

24. A quality assurance system according to claim 1 wherein the quality assurance system comprises a quality assurance document and the quality assurance document has a shape selected from the group consisting of rectangular, square, circular, arrow-shaped, a shape depicting an airplane, a bird, a train, a boat, a food product, a steak, a fish, a chocolate and a box of chocolates.

25. A quality assurance system according to claim 1 wherein the quality assurance document has a configuration selected from the group consisting of a single sheet, a trifold in concertina, gate-fold, or shutter-fold style, a concertina fold having four or more panels and a multi-page booklet.

26. A quality assurance system according to claim 1 wherein the host product quality assured comprises freshness or maturity and the quality assurance document evidences that the associated host product meets a maturity or freshness standard.

27. A quality assurance system according to claim 1 wherein the quality assurance system comprises a quality assurance document and the quality assurance document comprises the ambient condition indicator and recent-history ambient condition exposure information derived from real-time data generated by the ambient condition indicator.

28. A quality assurance system according to claim 1 further comprising a low-temperature spoilage indicator to indicate past exposure of a host product to an excessively low temperature.

29. A quality assurance system according to claim 1 further comprising an excess temperature exposure indicator to indicate the past occurrence of exposure to a temperature above a threshold temperature.

30. A quality assurance system according to claim 28 further comprising an excess temperature exposure indicator to indicate the past occurrence of exposure to a temperature above a threshold temperature.

31. A quality assurance system according to claim 1 in combination with a host product selected from the group consisting of a cooked food product, an uncooked food product, fruit, cheese, steak and smoked and/or aged meat products, a food service product, a prepared meal, an airline meal and an airline meal comprising one or more of uncooked fresh foodstuffs, hot cooked foodstuffs and cold cooked foodstuffs wherein the ambient condition is temperature and wherein the quality assured is freshness.

32. A quality assurance system according to claim 1 in combination with a host product selected from the group consisting of:
perishable products, foodstuffs;
fruit, vegetables, dairy products, milk, cream, yogurt, cheese, eggs, egg-containing products, baked products, breads, cakes, cookies, biscuits, pastries, pies;
fresh, cooked, cured or smoked meats and fish;
roasts, steaks, chops, and whole and split carcasses of beef, veal pork, lamb, goat, game domesticated meat and wild meat;
food service products, restaurant service foods, fresh cut foods, fruits and salads;
mail order supplied food products, public carrier delivered food products, gourmet fruits, chocolates, cheeses, fresh and cured meats, chicken, fowl and game;
ready-to-eat and ready-to-cook meals ordered by phone, mail or Internet and delivered to a residence or business;
perishable animal foods, pet foods, foods for agricultural, zoological and other animals;
food additives, aspartame;
cut and uncut flowers;
cosmetics, cosmetics containing biologicals, cosmetics containing labile ingredients,
beauty aids;
biological materials for industrial or therapeutic uses, cultures, organs, human body parts, animal body parts, blood, perishable blood products;
diagnostic devices, kits and ingredients containing perishables;
perishable health care products, vaccines, drugs, medicaments, pharmaceuticals, medical devices and prophylactics;
perishable munitions and ordnance including munitions prone to become unstable in response to exposure to an ambient condition, shells, bullets, mines, bombs, torpedoes, warheads, packaged solid, semisolid, plastic or liquid explosive and detonators;
perishable skin decontamination packs and products intended to remove or neutralize chemical warfare or toxins from the skin;
perishable chemical or biological agent detection kits useful for detecting exposure to nerve agents, blood agents, blister agents, or other toxic agents;
perishable photographic supplies;
perishable chemicals, perishable industrial supplies and solder paste.

33. A quality assurance system according to claim 1 in combination with a maturing or matured host product selected from the group consisting of: fruits; apples; pears; kiwis; melons; grapes; grapefruit; bananas; peaches; nectarines; plums; pineapples; mangoes; guavas; dates; papayas; plantain; avocadoes; peppers; tomatoes; cheeses; soft cheese; brie cheese; camembert cheese; hard cheese; cheddar cheese; aging beef; aging steak; other aging meats and meat products; aging gourmet meats; gourmet hams; pheasant; gourmet game products; aging sausages; wines; Bordeaux wine, burgundy wine; claret; champagne; port; whisky; cognac; beverages that can benefit from maturation; and maturing consumable products lacking an inherent visual indication of maturity.

34. An active cold chain compliance monitor for monitoring the compliance of a cold chain having multiple distribution stages with prescribed cold standards, the active cold chain compliance monitor comprising:
(a) an integrated time-temperature indicator for providing a current visual indication of the cumulative exposure of the active compliance monitor to temperature over time wherein the time-temperature indicator has an active component providing a changing visual response to cumulative ambient temperature; and
(b) a record area providing multiple stage records corresponding one to each with said distribution stages the records being marked for completion with chronological notations, distribution stage identification and information regarding the visual appearance of the time-temperature indicator when the active compliance monitor was at the respective distribution stage.

35. An active cold chain compliance record according to claim 34 comprising a visual scale for describing the appearance of the time-temperature indicator, the visual scale comprising multiple visual simulations of the appearance of the time-temperature indicator at different degrees of cumulative temperature exposure and notations for referencing the visual simulations wherein the compliance record provides for each stage record to be given a notation indicative of one of said visual simulations.

36. An active cold chain compliance monitor according to claim 35 wherein the time-temperature indicator and each visual simulation each have an indicator area and a reference area adjacent the indicator area, wherein the reference area has a visual appearance corresponding with the appearance of the time-temperature indicator at a cumulative temperature exposure limit.

37. A method of assuring the quality of a specific host product having a quality characteristic time related to exposure of the host product to an ambient condition, wherein the method comprises:
(a) employing a quality assurance system comprising an ambient condition indicator for providing a current visual indication of the cumulative exposure over time of the host product to the ambient condition wherein the ambient condition indicator has an active component selected to provide a visual response to the ambient condition in a manner correlated with the response characteristics of the specific host product to the ambient condition and comprising a historical record for recording a historical visual indication of cumulative exposure over time of the host product to the ambient condition at a prior point in time;
(b) at said prior point in time, observing the appearance of the ambient condition indicator; and
(c) at said prior point in time, recording the appearance of the ambient condition indicator in the historical record.

38. A method according to claim 37 wherein the specific host product comprises a food service meal, wherein the quality assured is freshness, wherein the ambient condition is temperature and wherein the prior point in time is during preparation of the food service meal.

39. A method according to claim 38 wherein the quality assurance system comprises a quality assurance document comprising serving the meal to a customer and displaying to the customer, when served, the ambient condition indicator and the historical record in the quality assurance document.

40. A method according to claim 39 the method being effected by an entity having a facility to accommodate a food-consuming population and wherein the method comprises service of multiple ones of said food service meals to the food-consuming population, each meal being accompanied by one of said quality assurance documents, including the ambient condition indicator.

41. A method according to claim 40 wherein the entity is selected from the group consisting of cafeterias, restaurants, caterers, residential institutions, governmental facilities, corporations, nursing homes, schools, boats, ships, trains, food delivery services and other food service facilities.
